(19) United States
(12) Patent Application Publication
(10) Pub. No.: US 2010/0181160 A1
(43) Pub. Date: Jul. 22, 2010

(54) ONE-WAY CLUTCH OF SPRAG TYPE

(76) Inventors: Yukiyoshi Suzuki, Shizuoka-ken (JP); Tsutomu Kawai, Shizuoka-ken (JP)

Correspondence Address: MILES & STOCKBRIDGE PC, 1751 PINNACLE DRIVE, SUITE 500, MCLEAN, VA, 22102-3833, US

(21) Appl. No.: 12/668,389

(22) PCT Filed: Jul. 10, 2007
(86) PCT No.: PCT/JP2007/064045

§ 371 Date: Jan. 8, 2010

(51) Int. Cl. F16D 41/069

(52) U.S. Cl. 192/41 A

(57) ABSTRACT

The present invention provides a one-way clutch of sprag type comprising outer and inner races spaced apart from each other in a radial direction and concentrically disposed to allow a relative rotation therebetween, the outer race having an inner peripheral track surface and the inner race being disposed within the outer race and having an annular outer peripheral track surface; a plurality of sprags disposed between the outer race and the inner race and capable of transmitting torque between the inner peripheral track surface of the outer race and the outer peripheral track surface of the inner race; a cage for holding the sprags; and a spring for biasing the sprags, and wherein a strut angle at an initial engaging height of the sprag is smaller than 2°.

### TECHNICAL FIELD

The present invention relates to a one-way clutch of sprag type used in vehicles and the like.

### BACKGROUND ART

In general, a one-way clutch of sprag-type comprises an outer race, an inner race rotatable relative to the outer race, and sprags as torque transmitting members for transmitting torque between the outer race and the inner race. As the inner and outer races are rotated relative to each other, the sprags are engaged with an outer peripheral surface of the inner race and/or an inner peripheral surface of the outer race, thereby transmitting the torque between the inner and outer races.

Further, in the one-way clutches of sprag-type, generally, a cam surface of the sprag is designed in such a manner that a center of a radius of curvature of an outer cam surface is deviated from a center of a radius of curvature of an inner cam surface so that, as the sprag is rotated in an engaging direction, a height of the sprag is increased.

In this case, the sprag must satisfy a relationship, a μ>tan α, required for the engagement, where μ is coefficient of friction and α is a strut angle. A method for measuring such a strut angle is disclosed in Japanese Patent Application Laid-Open No. H02-206713.

Engine oil includes an extreme-pressure additive such as organic molybdenum. Thus, the engine oil has low coefficient of friction. Accordingly, in the engagement of the one-way clutch, the relationship between the coefficient of friction μ and the strut angle α becomes tan α>μ, with the result that slip is generated between the sprag and the inner race and the sprag cannot be engaged by the inner race. As a result, the engaging function of the one-way clutch may not be achieved.

Further, in a case where the one-way clutch is used under severe engine vibration, particularly, during an idle rotation, there may cause a problem regarding wear of the inner diameter side of the sprag.

### DISCLOSURE OF THE INVENTION

Accordingly, an object of the present invention is to provide a one-way clutch of sprag type capable of maintaining a reliable engaging ability even under a condition in which engine vibration is severe and a lubricating condition in which a coefficient of friction of an extreme-pressure additive in engine oil is low.

To achieve the above object, the present invention provides a one-way clutch of sprag type comprising outer and inner races spaced apart from each other in a radial direction and concentrically disposed to allow a relative rotation therebetween, the outer race having an inner peripheral track surface and the inner race being disposed within the outer race and having an annular outer peripheral track surface; a plurality of sprags disposed between the outer race and the inner race and capable of transmitting torque between the inner peripheral track surface of the outer race and the outer peripheral track surface of the inner race; a cage for holding the sprags; and a spring for biasing the sprags, and wherein a strut angle at an initial engaging height of the sprag is smaller than 2°.

According to the present invention, the following effects can be obtained.

By selecting the strut angle at the sprag height represented by “initial engaging height of sprag=(a diameter of the inner peripheral track surface of the outer race−a diameter of the outer peripheral track surface of the inner race)/2” to become smaller than 2° (preferably, 1.2 to 1.8°) and by selecting the strut angle in a normal engaging area (torque load) to become smaller than 3°, even in an environment in which lubricating oil including extreme-pressure agent and having low coefficient of friction is used, a reliable one-way clutch of sprag type which provides positive engagement can be provided.

In the specification, methods for measuring the height of the sprag and the strut angle are performed in accordance with methods described in FIG. 1 of the above-mentioned Japanese Patent Application Laid-Open No. H02-206713. In the present invention, the strut angle is smaller than 2° (preferably, 1.2° to 1.8°) at the initial engaging height of the sprag and is smaller than 3° in the normal engaging area (torque load). If the strut angle is too small, torque in the engaging direction cannot be obtained, and thus, the one-way clutch cannot be functioned.

Further, by designing the sprag so that a radial dimension or distance from centers of an outer diameter side cam surface and an inner diameter side cam surface of the cam configuration to the cam surface, in an idle rotation area where the height of the sprag is smaller than the initial engaging height, becomes smaller than a radial dimension of the cam surface constituting the outer diameter side cam surface and the inner diameter side cam surface in an engaging area where the height of the sprag is greater than the initial engaging height, since an allowable eccentric amount of the sprag can be increased, wear of the sprag and the inner race can be prevented. When the sprag is inclined toward the idle rotation side by a maximum value, since a space between the track surface of the inner race and the sprag can be increased, even if an eccentric load is applied, the sprag can be inclined, with the result that the sprag can escape from the excessive load applied from the inner peripheral track surface of the outer race or the outer peripheral track surface of the inner race.

Further features of the present invention will become apparent from the following description of exemplary embodiments with reference to the attached drawings.

### BRIEF DESCRIPTION OF THE DRAWINGS

FIG. 1 is an axial partial sectional view of a one-way clutch of sprag type according to an embodiment of the present invention;

FIG. 2 is a front view of a sprag shown in FIG. 1; and

FIG. 3 is a graph showing a curve representing a strut angle of the sprag measured in a parallel plane.

### BEST MODE FOR CARRYING OUT THE INVENTION

Now, embodiments of the present invention will be explained with reference to the accompanying drawings. Incidentally, it should be understood that embodiments which will be described later are merely exemplary and do not limit the present invention in all senses.

Hereinbelow, the embodiments of the present invention will be fully described with reference to the accompanying drawings. Incidentally, in the drawings, the same elements are designated by the same reference numerals. Further, it should be noted that the embodiments are merely illustrative examples and do not limit the present invention.

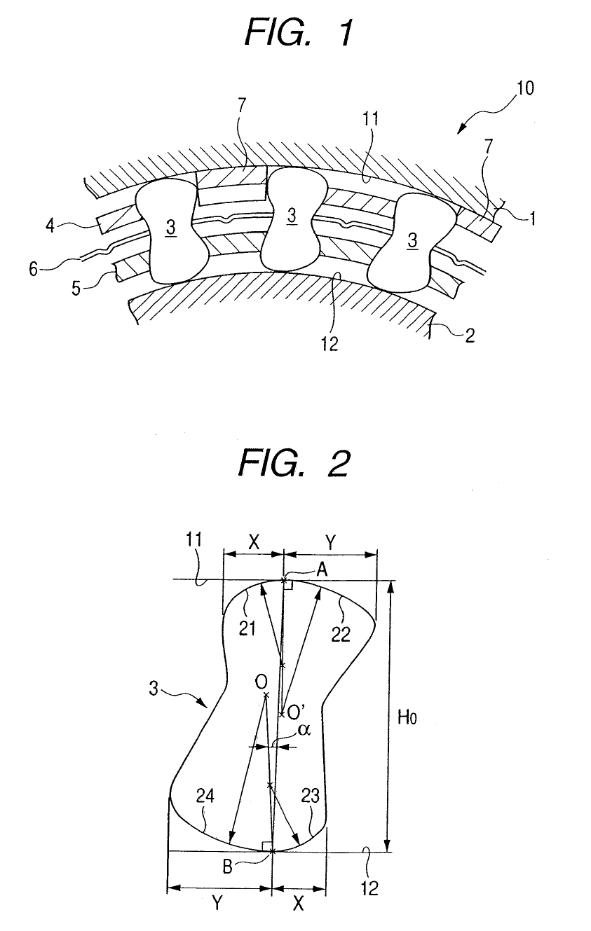

FIG. 1 is an axial partial sectional view of a one-way clutch 10 of sprag type according to an embodiment of the present invention. The one-way clutch 10 comprises an outer race 1 having an inner peripheral track surface 10, an inner race 2 rotatable relative to the outer race 1 and having an outer peripheral track surface 12, and a plurality of sprags 3 as torque transmitting members for transmitting torque between the outer race 1 and the inner race 2.

The sprags 3 are held by an outer cage 4 and an inner cage 5 which are disposed between the outer race 1 and the inner race 2. Further, a ribbon spring 6 is provided between the outer cage 4 and the inner cage 5, thereby providing cocking or rising moment for engaging each sprag with the outer peripheral track surface 12 of the inner race 2 to each sprag 3. Means 7 for applying friction forces to the outer race 1 are provided on the outer cage 4. For example, as the friction force applying means, a T-shaped bar, an i-bar obtained by bending a post portion of the cage and the like are known.

FIG. 2 is a front view of the sprag 3 of the one-way clutch 10 shown in FIG. 1. The sprag 3 has a gourd-shape in which the narrow parts are provided on both sides of the sprag at intermediate regions in a radial direction. Although different from the actual situation, for convenience sake of the explanation, FIG. 2 shows a condition that the inner peripheral track surface 11 of the outer race 1 is in parallel with the outer peripheral track surface 12 of the inner race 2.

The sprag 3 has cam surfaces 21 and 22 as curved surfaces having different radii and disposed on both sides of a contact point A where the inner peripheral track surface 11 is contacted with the sprag 3 (at the side of the outer race 1), and cam surfaces 23 and 24 as curved surfaces similarly having different radii and disposed on both sides of a contact point B where the outer peripheral track surface 12 is contacted with the sprag 3 (at the side of the inner race 2). In the illustrated embodiment, the radius of the cam surface 21 is substantially the same as the radius of the cam surface 23, and the radius of the cam surface 22 is substantially the same as the radius of the cam surface 24. Further, the radii of the cam surfaces 22 and 24 are greater than the radii of the cam surfaces 21 and 23.

The cam surface 21 at the outer diameter side of the sprag 3 corresponds to an area X (idle rotation area) where the height of the sprag 3 is smaller than an initial engaging height H₀ of the sprag, and the cam surface 22 corresponds to an area Y (engaging area) where the height of the sprag is greater than the initial engaging height H₀ of the sprag. Further, the cam surface 23 at the inner diameter side corresponds to corresponds to the area X (idle rotation area) where the height of the sprag 3 is smaller than the initial engaging height H₀ of the sprag, and the cam surface 24 corresponds to the area Y (engaging area) where the height of the sprag is greater than the initial engaging height H₀ of the sprag.

In FIG. 2, an angle α formed between a straight line extending from the contact point A to the contact point B and a center O of the curved cam surface 24 is defined as a strut angle of the sprag 3. In the illustrated embodiment, the strut angle α at the initial engaging height H₀ of the sprag 3 is set to be smaller than 2° and be preferably greater than 1.2° and smaller than 1.8°.

Incidentally, in FIG. 2, an angle formed between the inner peripheral track surface 11 and a center O′ of the cam surface 22, and an angle formed between the outer peripheral track surface 12 and the center O of the cam surface 24 are right angles (90°), respectively. However, to facilitate the explanation, since the strut angle is shown exaggeratedly, such angles look to be slightly smaller than the right angles in FIG. 2.

In an engaging area of the sprag where the height of the sprag 3 is greater than the initial engaging height H₀ of the sprag 3 by about 0.1 mm, the strut angle is smaller than 3°.

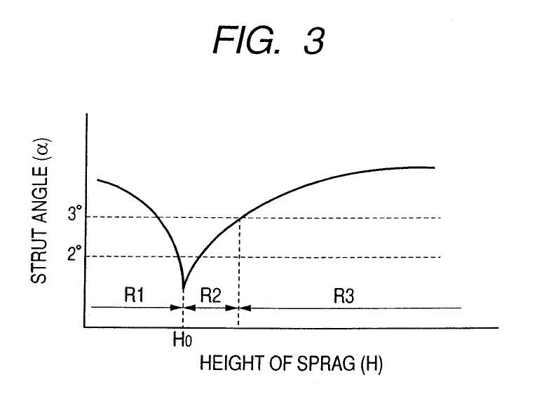

FIG. 3 is a graph showing a curve representing the strut angle measured in a parallel plane. The strut angle of the sprag 3 is shown as a strut angle with respect to the initial engaging height H₀ of the sprag 3, and FIG. 3 shows a representative strut angle curve according to the illustrated embodiment.

In general, in order to ensure that the sprag 3 does not generate slip, the strut angle α must be smaller and tan α must be smaller than coefficient of friction μ of steel; that is to say, a relationship tan α<μ must be satisfied. Further, if the strut angle is too small, since a torque capacity is reduced, the optimum strut angle must be achieved.

In FIG. 3, R1 shows an idle rotation area, and R2 and R3 show engaging areas. Among these areas, particularly, R2 shows the practical engaging area, which corresponds to the embodiment of the present invention. By setting the strut angle α in this way, a reliable engaging ability can be maintained even under a condition in which engine vibration is severe and a lubricating condition in which a coefficient of friction of an extreme-pressure additive in engine oil is low.

While an example that the one-way clutch of sprag type has both of the outer cage and the inner cage (one-way clutch of dual cage type) was explained, it should be noted that the present invention can also be applied to a one-way clutch of sprag type having a single cage. Further, the present invention can be applied to any one-way clutches having other sprags.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A one-way clutch of sprag type comprising:
outer and inner races spaced apart from each other in a radial direction and concentrically disposed to allow a relative rotation therebetween, said outer race having an inner peripheral track surface, said inner race being disposed within said outer race and having an annular outer peripheral track surface;
a plurality of sprags disposed between said outer race and said inner race and capable of transmitting torque between said inner peripheral track surface of said outer race and said outer peripheral track surface of said inner race;
a cage for holding said sprags; and
a spring for biasing said sprags;
and wherein
a strut angle at an initial engaging height of said sprag is smaller than 2°, wherein the strut angle is defined between a straight line extending from the contact point at which the inner peripheral track surface is in contact with the sprag to the contact point at which the outer peripheral track surface is in contact with the sprag, and a center of the curved cam surface of the sprag.

2. A one-way clutch of sprag type according to claim 1, wherein, in an engaging area of said sprag where a height of said sprag is greater than said initial engaging height of said sprag by 0.1 mm, the strut angle is smaller than 3°.

3. A one-way clutch of sprag type comprising:
a sprag designed so that a radial dimension from centers of an outer diameter side cam surface and an inner diameter side cam surface of a cam configuration to the cam surface, in an idle rotation area where a height of said sprag is smaller than an initial engaging height, becomes smaller than a radial dimension of said cam surface constituting said outer diameter side cam surface and said inner diameter side cam surface in an engaging area where the height of said sprag is greater than the initial engaging height.

4. A one-way clutch of sprag type according to claim 1, wherein said strut angle is 1.2° to 1.8°.
